(19) United States
(12) Patent Application Publication
(10) Pub. No.: US 2026/0204294 A1
(43) Pub. Date: Jul. 16, 2026

(54) INTERACTIVE VIDEO EDITING AND PLAYBACK STORAGE FORMAT SOLUTIONS

(71) Applicant: Microsoft Technology Licensing, LLC, Redmond, WA (US)

(72) Inventors: Brock Andrew KENZLER, Brisbane (AU); Soeren BALKO, Brookfield (AU)

(21) Appl. No.: 19/023,227

(22) Filed: Jan. 15, 2025

(51) Int. Cl. G11B 27/34; G11B 27/031

(52) U.S. Cl. CPC G11B 27/34; G11B 27/031

(57) ABSTRACT

Storage format solutions are disclosed for interactive video editing and playback that provide backwards compatibility for legacy players. Examples enable newer video players, that are able to extract dynamic content from the new video file format, to display both the underlying static video along with the dynamic content (according to a timeline within metadata stored in the new video file format), whereas legacy players display the static video. Some examples expose settings for the dynamic content to enable newer players to reconfigure the display of the dynamic content, making the video rendering an interactive experience. Use of references (e.g., URLs) within the dynamic content enables videos distributed in the new format updateable and correctable, such that information that is subject to change may be kept current, and informational errors introduced at the time of the video production may be corrected—without requiring creation and distribution of a substitute video file.

### BACKGROUND

Video is a domain that is currently strictly separated between editing and playback experiences, each of which cater to different audiences and use distinct software tools and capabilities. Common video editors, such as Clipchamp and others, enable users to assemble a timeline of media assets and effects, which they can subsequently export into a playable output video file (e.g., an MP4 file or another video file format). Common video players, such as Windows Media Player and others, are capable of playing video files in common video file formats, but with a constrained set of operations inspired by the physical buttons of VCRs, such as play, pause, seek, adjust playback speed, performing seek operations, and similar simple interactions. These operations do not allow for altering the content of the video being played.

Substantive changes to the video being displayed, and user interactions with individual objects displayed within the video (i.e., components less than the entire video frame) are not possible. In this sense, current conventional videos are static (i.e., their contents are fixed). Due to the limited available user operations, a viewer will typically merely start the video, possibly pausing, rewinding, fast forwarding, and/or changing playback speed, until the video playback completes or the viewer stops the playback.

Thus, video creators or editors must tailor the video content for viewing within the bounds of the traditional (tightly-limited) viewing operations. Further changes to the video, such as correcting errors in source material used (e.g., data displayed within the video), updating source material with newer information when it becomes available, or adjusting the viewing perspective of the source material is not possible after finalizing the video editing process, and saving and distributing the playable output video file. Updating a video with more current (or accurate) information, requires creation of a substitute video file and distributing the substitute with the hope that future viewers see the substitute video instead of the original video.

### SUMMARY

The disclosed examples are described in detail below with reference to the accompanying drawing figures listed below. The following summary is provided to illustrate some examples disclosed herein.

Storage format solutions are disclosed for interactive video editing and playback. Examples receive, into a video editor, static video data in a first video file format and metadata comprising dynamic content and a timeline of presenting the dynamic content along with the static video data; tag at least a first portion of the dynamic content of the metadata with a first tag to indicate dynamic content; assemble, into a second video file format, the static video data and the metadata comprising the dynamic content, the timeline of presenting the dynamic content, and the first tag; and store, by the video editor, the static video data and the metadata in the second video file format.

### BRIEF DESCRIPTION OF THE DRAWINGS

The disclosed examples are described in detail below with reference to the accompanying drawing figures listed below:

FIG. 1 illustrates an example architecture that advantageously provides for interactive video editing and playback storage format solutions;

FIG. 2 illustrates exemplary dynamic content, as may be used in examples of the architecture of FIG. 1;

FIG. 3 illustrates exemplary metadata, as may be used in examples of the architecture of FIG. 1;

FIG. 4 illustrates an exemplary output video file, as may be generated in examples of the architecture of FIG. 1;

FIGS. 5 and 6 show flowcharts illustrating exemplary operations that may be performed when using example architectures, such as the architecture of FIG. 1; and

FIG. 7 shows a block diagram of an example computing device suitable for implementing some of the various examples disclosed herein.

Corresponding reference characters indicate corresponding parts throughout the drawings.

### DETAILED DESCRIPTION

Storage format solutions are disclosed for interactive video editing and playback that provide backwards compatibility for legacy players. Examples enable newer video players, that are able to extract dynamic content from the new video file format, to display both the underlying static video along with the dynamic content (according to a timeline within metadata stored in the new video file format), whereas legacy players display the static video. Some examples expose settings for the dynamic content to enable newer players to reconfigure the display of the dynamic content, making the video rendering an interactive experience. Use of references (e.g., URLs) within the dynamic content enables videos distributed in the new format updateable and correctable, such that information that is subject to change may be kept current, and informational errors introduced at the time of the video production may be corrected—without requiring creation and distribution of a substitute video file.

Aspects of the disclosure solve multiple problems that are necessarily rooted in computer technology, and render use of computing platforms more efficient in highly common use cases, by providing the practical result of enabling already-distributed video files to be updated and/or corrected without requiring expensive creation and distribution of substitute video files. Additionally, examples convert video files, which have been static since their inception, into interactive experiences in which viewers are able to tailor and customize the presentation of individual objects within the video project. This significantly improves the ubiquitous use of computers for viewing video files distributed to large numbers of users over the internet, such as by emailing, posting on websites for download or online viewing, and shared over social media. These advantageous results are accomplished, at least in part, by tagging at least a first portion of the dynamic content of the metadata with a first tag to indicate dynamic content; and assembling, into a second video file format, the static video data and the metadata comprising the dynamic content, the timeline of presenting the dynamic content, and the first tag.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

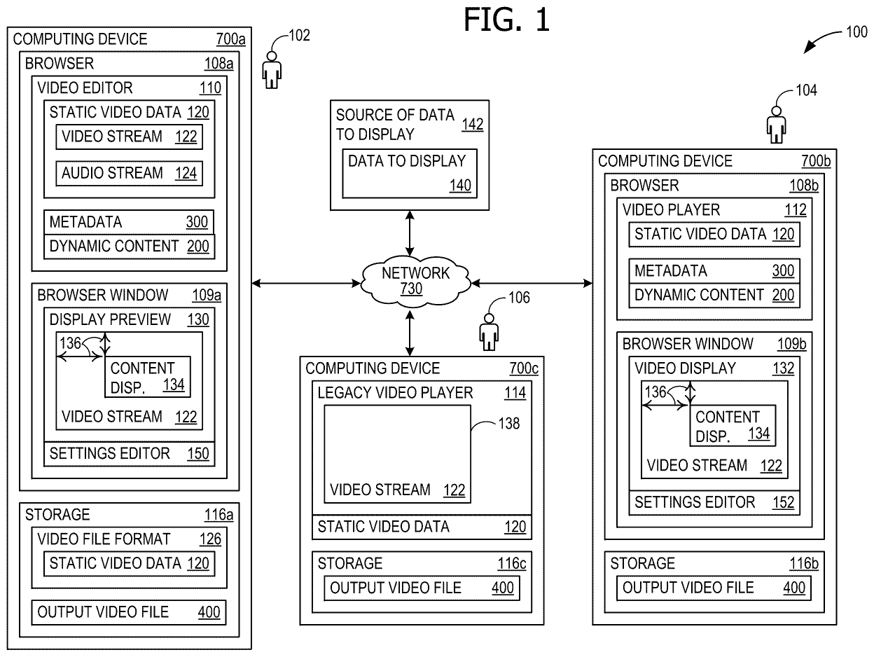

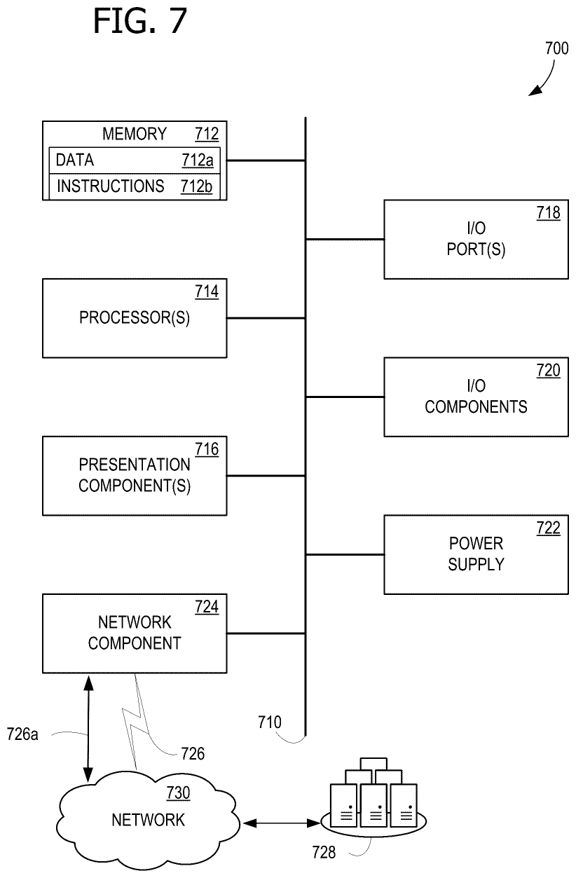

FIG. 1 illustrates an example architecture 100 that advantageously provides storage format solutions for interactive video editing and playback. A user 102 (a video creator) wishes to create a new video project combining both static video and dynamic content with which a viewer (e.g., user 104) may interact. User102 is using a computing device 700a, which may be an example of computing device 700 of FIG. 7. Computing device 700a has an internet browser 108a, which displays an internet browser window 109a, and a storage 116a. Storage 116a holds static video data 120 in a static video file format 126. Static video data 120 forms the underlying basis for the new video project, to which user 102 will add dynamic content 200.

Static video data 120 has a static video stream 122, and a static audio stream 124, which is synchronized to provide a sound track to static video stream 122. Static video data 120 (including static video stream 122 and static audio stream 124) are identified as static, because after finalization and distribution, the video and audio streams are not changeable. That is, the content is immutable by standard video players (such as a legacy video player 114, described below). In some examples, static video file format 126 is a legacy video file format, such as MP4, MOV, AVI, WMV, MKV, WebM, OGV, QYFf, or another. Some common media formats (e.g., MP4 containers) allow for multiple video streams, which may be used for different viewing perspectives (e.g., in sports broadcasts), and multiple audio streams (e.g., different languages). Some media players allow for switching between these static audio or video streams. Adjustment of volume, and switching among different static audio streams and/or static video streams does not render the content dynamic, as the term is used herein.

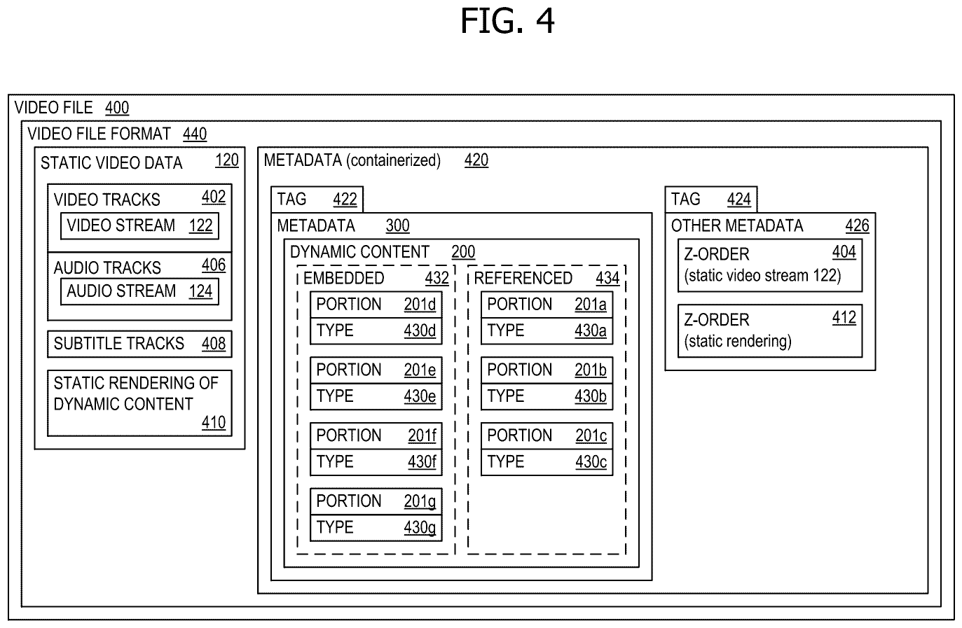

User 102 uses a video editor 110 to create the project and export (store) it as an output video file 400, such as in storage 116a. User 102 then distributes (output) video file 400 to other users (viewers), such as a user 104 and a user 106, such as by emailing, posting on a website, or sharing on social media. Video file 400 is shown in further detail in FIG. 4. Video editor 110 loads static video 120 to start the project. In some examples, video editor 110 comprises a plug-in to internet browser 108a, whereas in some other examples, video editor 110 executes remotely from internet browser 108a, but is shown within internet browser window 109a (i.e., the user interface of video editor 110 is displayed in internet browser window 109a). In some examples, video editor 110 executes as a stand-alone application on computing device 700a.

Using video editor 110, user 102 adds dynamic content 200 to the video project. Dynamic content 200 is the additional data to display along with static video data 120, when dynamic content 200 is a visual element, although dynamic content 200 may also include audio elements that are played (in addition to static audio stream 124). FIG. 1 shows two options for sourcing dynamic content 200, either loading data to display 140 from a source 142 across a computer network 730, or directly from storage 116a.

Adding dynamic content 200 may be accomplished by either including a reference (e.g., a URL) to data to display 140, located on source 142, or by including dynamic content 200 as encapsulated inline content (i.e., fully contained within video file 400). When adding video file 400 via reference, video file 400 is smaller and display of dynamic content 200 is kept up-to-date as it is updated on source 142—even years after the finalization and distribution of video file 400. Source 142 may be a server (such as another example of computing device 700), and computer network 730 may include the internet, as described below in relation to FIG. 7. When adding dynamic content 200 as inline data, video file 400 is larger but the availability of source 142 is not a potentially restraining issue. Data to display 140 may be a variety of objects, such as an online sourced video, an online sourced map, online sourced data file (e.g., spreadsheet, database), and online sourced two-dimensional (2D) image file, an online sourced three-dimensional (3D) object file, or another type of data. When provided as inline data, dynamic content 200 may include encapsulated content in the format of a common data file, such as JavaScript object notation (JSON), extensible markup language (XML), Advanced Authoring Format (AAF), a 2D image file format (e.g., BMP, JPG, PNG, etc.), and a 3D object file format

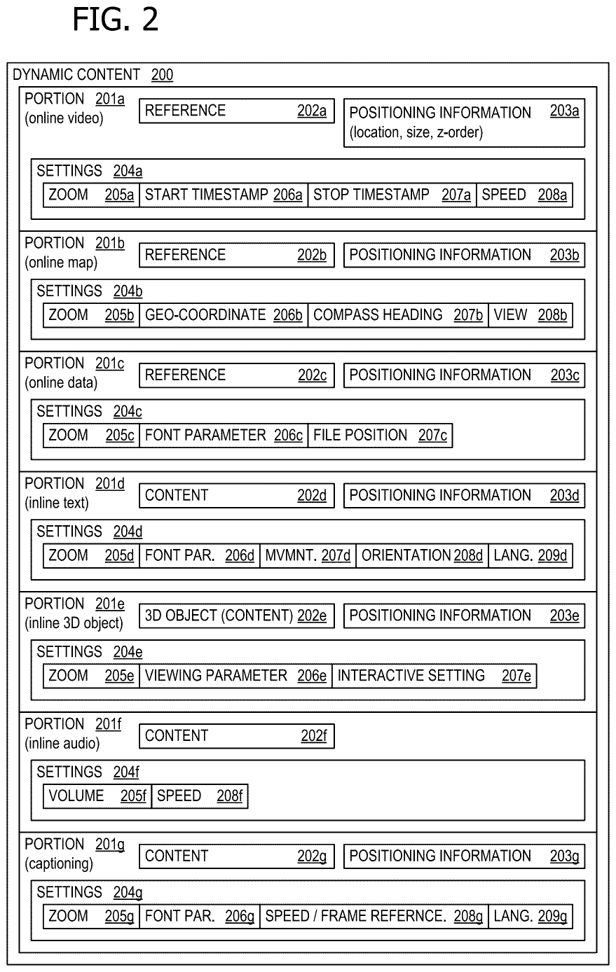

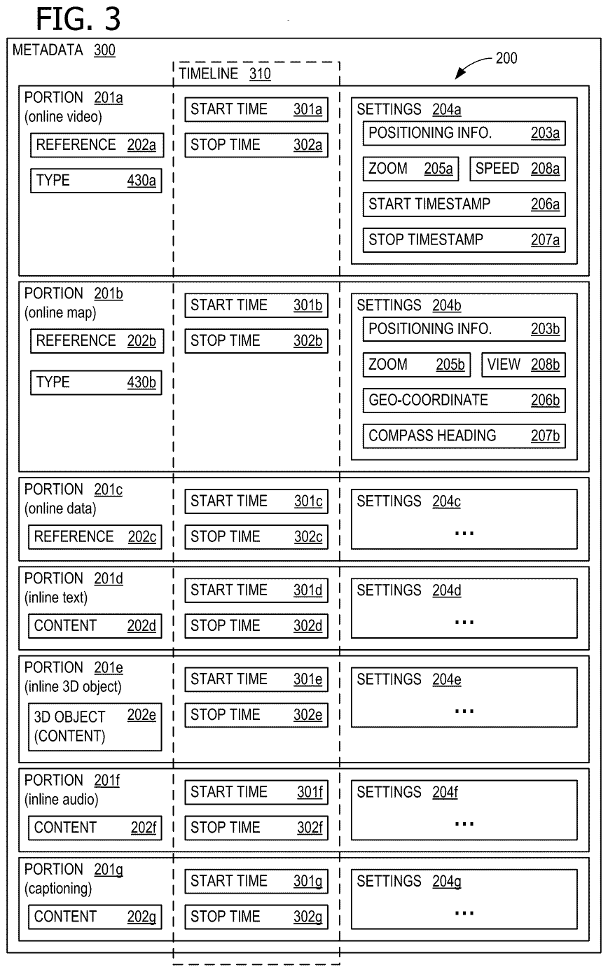

As user 102 edits the video project, a display preview 130 of video editor 110 shows a display 134 of dynamic content 200 (or at least a portion of dynamic content 200—see FIG. 2) along with static video data 120. Using a settings editor 150 of video editor 110, user 102 is able to set several parameters for the presentation of dynamic content 200, such as when during the playing of static video data 120 dynamic content 200 (or portions thereof) appear (i.e., a start time) and are removed (i.e., a stop time). Additionally, the presentation size of dynamic content 200, and its positioning and z-order in relation to other content on the timeline. Some examples use z-ordering to layer the displayed content. A z-order is an ordering of overlapping objects, that identifies which object is on top and which is beneath (and thus may be obscured). The start and stop times may be specified within a timeline 310 of metadata 300, which is shown in further detail in FIG. 3.

Other parameters for the presentation of dynamic content 200, which may be set by user 102 include a relative positioning 136 of display 134 of dynamic content 200 relative to the display of static video data 120 (i.e., display of static video stream 122, since static audio stream 124 is played as audio). Relative positioning 136 is illustrated as horizontal and vertical offsets from the top left corner of static video stream 122, although other ways to specify positioning may be used. Further example parameters for presentation of dynamic content 200 are shown in FIG. 2. When user 102 is satisfied with the video project, it is saved to storage 116a as output video file 400 and distributed.

User 104 is one of the viewers, and receives video file 400 into a storage 116b of a computing device 700b, which may be another example of computing device 700 of FIG. 7. User 104 uses a video player 112 that is able to display (present) dynamic content 200 along with static video data 120. In some examples, video player 112 comprises a plug-in to internet browser 108b on computing device 700b, whereas in some other examples, video player 112 executes remotely from internet browser 108b, but is shown within an internet browser window 109b of internet browser 108b (i.e., the user interface of video player 112 is displayed in internet browser window 109b). In some examples, video player 112 executes as a stand-alone application on computing device 700b.

Video player 112 loads video file 400 and extracts static video data 120, metadata 300, and dynamic content 200. Video player 112 plays static video data 120 within a video display 132 of video player 112. At the times specified by timeline 310 of metadata 300, the various portions of dynamic content 200 are displayed along with static video data 120 (i.e., static video stream 122). Some examples of video player 112 may leverage online 3D object rendering and display engines, such as Babylon.js, or a full gaming engine. Babylon.js is a JavaScript library and 3D engine for displaying real time 3D graphics in a web browser via HTML5.

Dynamic content 200 is positioned according to relative positioning 136 of display 134 of dynamic content 200 relative to the display of static video data 120. In some examples, user 104 is able to use a settings editor 152 of video player 112 adjust at least some parameters for the presentation of dynamic content 200. The ability of user 104 to adjust parameters of the presentation of dynamic content 200 may have been specified by user 102 and the limits/permissions stored within metadata 300 or dynamic content 200 itself. In some examples, settings of the parameters of the presentation of dynamic content 200 are exposed via an API accessed by video player 112.

In some scenarios, another user 106 also receives video file 400. User 106 uses a computing device 700c (e.g., another example of computing device 700 of FIG. 7). Computing device 700c has a storage 116c and a legacy video player 114. Video player 114 may run as a standalone application on computing device 700c or within an internet browser. Video player 114 loads video file 400 from storage 116c, but lacks the functionality to display dynamic content 200 along with static video data 120.

Generally, video players ignore video file content that is tagged with a tag that the video player does not recognize. As is described below, dynamic content 200 is containerized and tagged, so that it is recognized, by video player 112, as holding dynamic content 200. However, legacy video players, such as video player 114, ignore dynamic content 200 and do not display it. This feature of legacy video players renders the disclosure herein backwards-compatible, such that static video is shown by legacy video players, while newer video players, that are compatible with the disclosure herein, do display dynamic content 200.

Video player 114 ignores containerized metadata having tags that legacy video player 114 is not programmed to recognize, but plays static video data 120 (static video stream 122 and static audio stream 124), showing a display 138 of static video stream 122. This backwards compatibility thus introduces a compromise: static video data 120 is viewable by user 106, but without dynamic content 200 as dynamic objects. In some examples, dynamic content 200 may be represented by static placeholder content instead, such as a rendering of a 3D object which may be animated (i.e., a camera may “fly” through a rendered 3D scene, or a 3D object rotates).

FIG. 2 illustrates further detail for dynamic content 200, with seven separate portions shown. Some examples may have a different count of dynamic content portions, each of which may be displayed separately, in different positions, and/or with different start and stop times. Portion 201a of dynamic content 200 is an online sourced video, included within dynamic content 200 by a reference 202a, such as a URL or hyperlink, (as opposed to being included as data that is encapsulated within video file 400). For example, online sourced video may be additional data to be displayed, which is sourced from source 142 as data to display 140. In such a scenario, reference 202a points to (references) source 142.

This permits display of the online sourced video to be kept up-to-date as it is updated on source 142—even years after the finalization and distribution of video file 400. Positioning information 203a specifies relative positioning 136 for display 134 of portion 201a of dynamic content 200, along with presentation size and layering information in relation to other content that is displayed concurrently. Some examples use z-ordering to layer the displayed content. A z-order is an ordering of overlapping objects, that identifies which object is on top and which is beneath (and thus may be obscured).

Settings 204a specify parameters for the presentation (e.g., display) of dynamic content 200, as set by user 102 using settings editor 150 of video editor 110. The settings for a portion of dynamic content 200 may be specific to the type of content. For example, for the online sourced video of portion 201a, settings 204a has a zoom factor 205a, a start timestamp 206a, a stop timestamp 207a, and a speed indication 208a (a playback speed). Note that start timestamp 206a and stop timestamp 207a are time indices within the online video of starting and stopping play, in the event that the entirety of the online sourced video is not played (i.e., only an excerpt of the online sourced video is played as dynamic content 200). Speed indication 208a enables playing the online sourced video at a different speed relative to static video data 120.

Portion 201b of dynamic content 200 is an online sourced map, included within dynamic content 200 by a reference 202b, such as a URL or hyperlink. For example, an online sourced map may be sourced from source 142 as data to display 140. In such a scenario, reference 202b points to source 142. Positioning information 203b specifies relative positioning 136 for display 134 of portion 201b, along with sizing and layering. Settings 204b specify parameters for the presentation of portion 201b of dynamic content 200, as set by user 102 using settings editor 150 of video editor 110. For example, for the online sourced map of portion 201b, settings 204b differs from settings 204a because presenting a map is different than presenting video. Settings 204b has a zoom factor 205b, a geo-coordinate 206b, a compass heading 207b, and a view 208b. View 208b may specify a traditional map view, street view (typically photographs), a satellite view, or another view common to online mapping functions.

Portion 201c of dynamic content 200 is an online sourced data file, included within dynamic content 200 by a reference 202c, such as a URL or hyperlink. For example, an online sourced data file may be sourced from source 142 as data to display 140. In such a scenario, reference 202c points to source 142. Positioning information 203c specifies relative positioning 136 for display 134 of portion 201c, along with sizing and layering. Settings 204c specify parameters for the presentation of portion 201c of dynamic content 200, as set by user 102 using settings editor 150 of video editor 110. For example, for the online sourced data file of portion 201c, settings 204c has a zoom factor 205c, a font parameter 206c, and a file position 207c. Font parameter 206c may be one or more of style (e.g., Arial or Times New Roman), size, or color. File position 207c may be a file pointer position, a database key, a spreadsheet cell range, or another specifier of a selection (less than all) from of a data file.

Portion 201d of dynamic content 200 is inline text, in which the content 202d to display is fully contained within dynamic content 200, possibly encapsulated in a common data file format, and stored within video file 400. Combinations of encapsulated and referenced data are also possible. Positioning information 203d specifies relative positioning 136 for display 134 of portion 201d, along with sizing and layering. Settings 204d specify parameters for the presentation of portion 201d of dynamic content 200, as set by user 102 using settings editor 150 of video editor 110. For example, for the inline text of portion 201d, settings 204d has a zoom factor 205d, a font parameter 206d, a movement indicator 207d (i.e., whether and how the text moves while being displayed), and orientation 208d (horizontal, vertical, or angled), and a language indicator 209d. If content 202d is an encapsulated data file, it may be in the format of simple ASCII test, JSON, XML, AAF, or another format.

Portion 201e of dynamic content 200 is an inline 3D object (or 2D image), in which the content 202e to display is contained within dynamic content 200, possibly encapsulated in a common data file format, and stored within video file 400. Positioning information 203e specifies relative positioning 136 for display 134 of portion 201e, along with sizing and layering. Settings 204e specify parameters for the presentation of portion 201e of dynamic content 200, as set by user 102 using settings editor 150 of video editor 110. For example, for the inline 3D object of portion 201e, settings 204e has a zoom factor 205e, a viewing parameter 206e, and an interactive setting 207e that specifies whether a viewer (e.g., user 104) is able to adjust zoom factor 205e and/or viewing parameter 206e. It is common to represent 3D objects as scene graphs in 3D space. Interactions with the 3D object that adjust a viewing parameter may include moving the camera around in 3D space (i.e., moving the position of the viewing point), and changing the viewing angle (azimuth and/or elevation where the viewing angle is pointing). Other viewing parameter adjustments may include adding light sources, and adding or removing other objects within the scene graph, or changing position and orientation (i.e., applying affine transformations). If content 202e is an encapsulated data file, it may be in a common a 3D object file format or a 2D image file format.

Portion 201f of dynamic content 200 is inline audio, in which the content 202f to play is contained within dynamic content 200, possibly encapsulated in a common data file format, and stored within video file 400. Positioning information is not needed. Settings 204f specify parameters for the presentation of portion 201f of dynamic content 200, as set by user 102 using settings editor 150 of video editor 110. For example, for the inline audio of portion 201f, settings 204f has a volume setting 205f (zoom is not relevant) and a speed indication 208f (playback speed). Speed indication 208f enables playing the inline audio at a different speed relative to static audio stream 124. If content 202f is an encapsulated data file, it may be in a common audio file format, such as mp3, WAV, or another format.

Portion 201g of dynamic content 200 is an inline closed captioning, in which the content 202g to display is contained within dynamic content 200, possibly encapsulated in a common data file format, and stored within video file 400. Closed captioning text may be grouped and indexed by language, so that a selected language is used during presentation of the video project. Positioning information 203g specifies relative positioning 136 for display 134 of portion 201g. Settings 204g specify parameters for the presentation of portion 201g of dynamic content 200, as set by user 102 using settings editor 150 of video editor 110. For example, for the inline closed captioning of portion 201g, settings 204g has a zoom factor 205g, a font parameter 206g, a speed indication or frame reference 208g, and a language specification 209g. Language specification 209g, which may be changed by user 104 using settings editor 152, in some examples, invokes a selected language from content 202g (when supported).

FIG. 3 illustrates further detail for metadata 300. Metadata 300 includes dynamic content 200 and timeline 310 that spans the portions of dynamic content 200, and which has a start time and/or a stop time for various ones of the portions. The start times and stop times for the different portions may all be independent (and thus different), with the limitation that any portions of dynamic content that start at the very beginning of playing the resulting video will have the same start times, as well as any portions of dynamic content that do not stop until the very end of playing the resulting video will similarly have the same stop times. For ease of illustration, details are only shown for settings 204a of portion 201a and settings 204b portion 201b. For the content of settings 204c through settings 204g, refer to FIG. 2.

As illustrated, portion 201a (online sourced video) has a start time 301a and a stop time 302b. These are distinguishable from start timestamp 206a and stop timestamp 207a in that start time 301a refers to the timing of playing static video data 120, whereas start timestamp 206a is a time index within the source video that is played as dynamic content, and stop time 302a refers to the timing of playing static video data 120, whereas stop timestamp 207a is another time index of the source video. An optional type tag 430a is added as metadata, and indicates that portion 201a of dynamic content is a referenced element, rather than an embedded element. Further description of type tags is provided in reference to FIG. 4.

Also as illustrated, portion 201b (online sourced map) has a start time 301b and a stop time 302b, indicating when during the playback of static video data 120, the online sourced map is to be displayed. An optional type tag 430b is added as metadata, and indicates that portion 201a of dynamic content is a referenced element. Portion 201c (online sourced data file) has a start time 301c and a stop time 302c, indicating when during the playback of static video data 120, selected data from the online sourced data file is to be displayed. Portion 201d (inline text) has a start time 301d and a stop time 302d, indicating when during the playback of static video data 120, the text is to be displayed.

Portion 201e (inline 3D object) has a start time 301e and a stop time 302e, indicating when during the playback of static video data 120, the 3D object is to be displayed. Portion 201f (inline audio) has a start time 301f and a stop time 302f, indicating when during the playback of static video data 120, the audio is to be played. Portion 201g (closed captioning) has a start time 301g and a stop time 302g, indicating when during the playback of static video data 120, the closed captioning is to be displayed. Type tags may also be included for portion 201c through portion 201g, as shown in FIG. 4.

FIG. 4 illustrates further detail for video file 400. Video file 400 contains static video data 120 and containerized metadata 420. Video file 400 uses a video file format 440, which may be the same format as legacy video files, such as MP4, MOV, AVI, WMV, MKV, WebM, OGV, and QTFF, or another common video file format. This provides backward compatibility with legacy video players (legacy media players), such as video player 114, when static video data 120 is included within video file 400. In some examples, video file does not contain static video data 120, but instead only has dynamic content 200 as the playable content.

Static video data 120 contains a video tracks data field 402 that holds static video stream 122, and which is given a z-order 404, that is held in other metadata 426 within containerized metadata 420. Other metadata 426 is tagged with a tag 424 that is recognized by both video player 112 and (legacy) video player 114. Thus, both video player 112 and video player 114 will display static video stream 122 according to z-order 404. Static video data 120 also contains an audio tracks data field 406 that holds static audio stream 124, and a static rendering 410 of dynamic content 200. A z-order 412 for static rendering 410 is within other metadata 426. Static video data 120 may further contain a subtitle tracks data field 408.

Because video player 114 recognizes tag 424, video player 114 will display static rendering 410 of dynamic content 200 according to z-order 412 (e.g., possibly obscuring all or a portion of static video stream 122). Video player 112 also recognizes tag 424, but video player 112 will obscure static rendering 410 with dynamic content 200 itself.

Containerized metadata 420 also holds metadata 300, which is tagged with a tag 422 that is recognized by video player 112 as indicating dynamic content, but is not recognized by legacy video players, such as video player 114. Thus, video player 114 will ignore metadata 300 and dynamic content 200. The z-order for each of the portions of dynamic content 200 is within the positioning data (see FIG. 2), and will result in video player 112 placing dynamic content 200 over top of static rendering 410 of dynamic content 200.

As described earlier, dynamic content may have embedded (inline) content or referenced content, or both. Metadata 300 is shown with both embedded dynamic content 432 and referenced dynamic content 434, although the grouping shown in FIG. 4 may not be used. Each of portion 201a through portion 201g is shown as having its own type tag that identifies it as either an embedded element or a referenced element. Portion 201a has a type tag 430a identifying an embedded element; portion 201b has a type tag 430b identifying an embedded element; portion 201c has a type tag 430c identifying an embedded element; portion 201d has a type tag 430d identifying an embedded element; portion 201e has a type tag 430e identifying an embedded element; portion 20fd has a type tag 430f identifying an embedded element; and portion 201g has a type tag 430g identifying an embedded element. That is, each of type tag 430a through type tag 430c may be the same type tag (i.e., an embedded type tag), and each of type tag 430d through type tag 430g may be the same type tag (i.e., a referenced type tag)

When each of portion 201a through portion 201g is individually tagged, the different portions may be intermixed (i.e., in random order) within metadata 300 within video file 400. However, alternatively, embedded dynamic content 432 (portion 201d through portion 201g) and referenced dynamic content 434 (portion 201a through portion 201c) may be grouped within metadata, and the entire group tagged with a single type tag. In such alternative examples, type tag 430a is used for all of referenced dynamic content 434 (portion 201a through portion 201c), type tag 430d is used for all of embedded dynamic content 432 (portion 201d through portion 201g) and the other type tags are not needed (type tag 430b, type tag 430c, type tag 430e, type tag 430f, and type tag 430g). In some examples, type tag 430a and/or type tag 430d renders tag 422 somewhat duplicative, and tag 422 is not used. That is, without the use of tag 422, legacy video players, such as video player 114 ignore everything within metadata 300 because everything within metadata is tagged with a type tag (e.g., at least one of type tag 430a through type tag 430g).

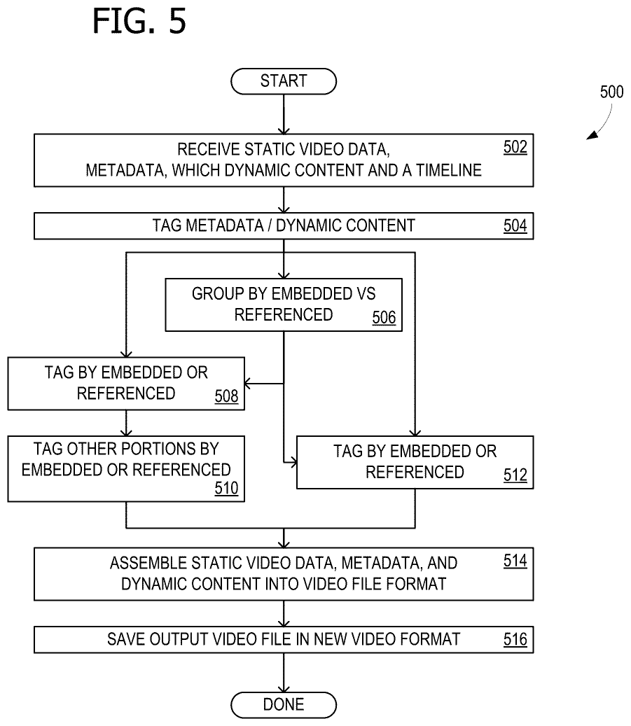

FIG. 5 shows a flowchart 500 illustrating exemplary operations that may be performed by architecture 100. In some examples, operations described for flowchart 500 are performed by computing device 700 of FIG. 7. Flowchart 500 commences with video editor 110 receiving static video data 120 and metadata 300, in operation 502. Originally, video editor 110 may receive only dynamic content 200, but then it generates metadata 300 as user 102 is editing the video project. Operation 502 concludes with video editor 110 having both static video data 120 and metadata 300.

There are multiple options for tagging metadata 300 and dynamic content 200, which are described in several scenarios that use various combinations of operations 504-512. Flowchart 500 moves to operation 514 after completing the operations described with a given scenario. One scenario is that only a single tag (tag 422) is used to identify metadata 300, and type tags (type tag 430a through type tag 430g) are not used. This scenario uses only operation 504. In another scenario, tag 422 is used to identify metadata 300, and further, embedded dynamic content 432 is grouped and tagged collectively with type tag 430d while referenced dynamic content 434 is grouped and tagged collectively with type tag 430a. This scenario uses operations 504, 506, and 508. In another scenario, tag 422 is used to identify metadata 300, and further, each portion of dynamic content 200 is tagged individually with a type tag (as shown in FIG. 4). This scenario uses operations 504, 508, and 510 (and optionally, operation 506).

Another class of scenarios avoids using tag 422 to identify the entirety of metadata 300 as generic dynamic content, but instead uses only type tags. One of these scenarios groups embedded dynamic content 432 and referenced dynamic content 434, and collectively tags these groups using type tag 430d (embedded content) and type tag 430a (referenced content). This scenario uses operations 506, 504, and 512—although operation 506 is performed prior to operation 504 in this scenario. In another scenario of this class, each portion of dynamic content 200 is tagged individually with a type tag. This scenario uses operations 504 and 512 (and optionally, operation 506).

Operation 504 tags at least a portion of dynamic content 200 of metadata 300 with a first tag to indicate dynamic content. When tag 422 is used, the first tag is tag 422 and the entirety of metadata 300 is tagged with it. When tag 422 is not used, the first tag is a type tag (embedded or referenced) and only portions of a single type are tagged with it (either collectively or individually). Portions of the other type are tagged with the other type tag in operation 512.

Operation 506 groups embedded dynamic content 432 and referenced dynamic content 434. This is performed when embedded dynamic content 432 and referenced dynamic content 434 are tagged collectively, but may also optionally be performed even when embedded dynamic content 432 and referenced dynamic content 434 are tagged individually. When tag 422 is not used, and the first tag (of operation 504) is a type tag, operation 506 preceded operation 504.

Operation 508 is only performed when tag 422 is used. Operation 508 tags at least a portion of dynamic content 200 (i.e., one or more of portions 201d-201g) with an embedded type tag (e.g., type tag 430d) to indicate embedded dynamic content, and/or tags another portion of dynamic content 200 (i.e., one or more of portions 201a-201c) with a referenced type tag (e.g., type tag 430a) to indicate referenced dynamic content. These are the type tags that are illustrated in FIG. 4 as being inside metadata 300, rather than tagging metadata 300 as a whole.

If embedded dynamic content 432 and referenced dynamic content 434 are tagged collectively, the type tags applied in operation 508 are for the entire groupings, and flowchart 500 then moves to operation 514. However, if instead embedded dynamic content 432 and referenced dynamic content 434 are tagged individually, flowchart 500 moves to operation 510 to tag the other portions. Operation 510 tags the remaining portions of dynamic content 200 with the embedded type tag to indicate embedded dynamic content or the referenced type tag to indicate referenced dynamic content.

Operation 512 is only performed when tag 422 is not used. Operation 512 separately tagging at least a portion of dynamic content 200 of metadata 300 with a second tag, which is the other type tag that was not used in operation 504. For example, if operation 504 applied an embedded type tag to indicate embedded dynamic content, operation 512 applies a referenced type tag to indicate referenced dynamic content - or vice versa. This may be performed for tagging collectively, or individually tagging the different portions of dynamic content 200.

In operation 514, video editor 110 assembles static video data 120 and metadata 300, which has dynamic content 200, timeline 310, and at least one tag, into video file format 440. In operation 516, video editor 110 stores static video data 120 and metadata 300 in video file format 440 as output video file 400. Video file format 126 and/or video file format 440 may be any of: MP4, MOV, AVI, WMV, MKV, WebM, OGV, and QTFF (or another). Additionally, video file format 126 may be the same as, or different than, video file format 440.

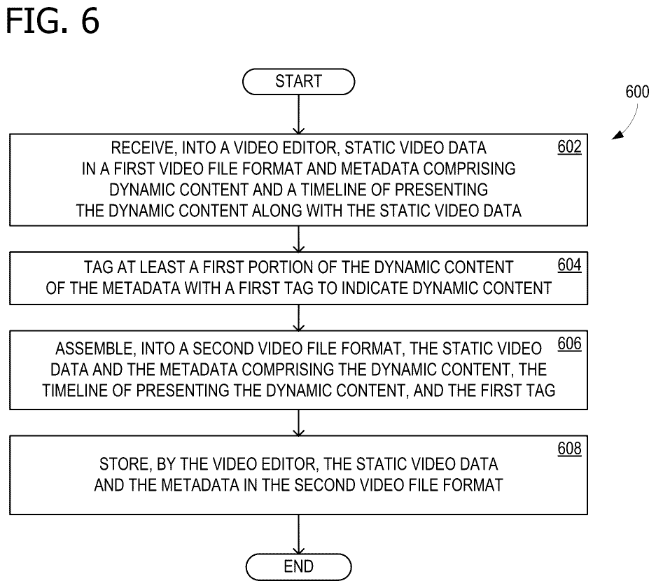

FIG. 6 shows a flowchart 600 illustrating exemplary operations that may be performed by architecture 100. In some examples, operations described for flowchart 600 are performed by computing device 700 of FIG. 7. Flowchart 600 commences with operation 602, which includes receiving, into a video editor, static video data in a first video file format and metadata comprising dynamic content and a timeline of presenting the dynamic content along with the static video data.

Operation 604 includes tagging at least a first portion of the dynamic content of the metadata with a first tag to indicate dynamic content. Operation 606 includes assembling, into a second video file format, the static video data and the metadata comprising the dynamic content, the timeline of presenting the dynamic content, and the first tag. Operation 608 includes storing, by the video editor, the static video data and the metadata in the second video file format.

### Additional Examples

An example system comprises: a processor; and a computer-readable medium storing instructions that are operative upon execution by the processor to: receive, into a video editor, static video data in a first video file format and metadata comprising dynamic content and a timeline of presenting the dynamic content along with the static video data; tag at least a first portion of the dynamic content of the metadata with a first tag to indicate dynamic content; assemble, into a second video file format, the static video data and the metadata comprising the dynamic content, the timeline of presenting the dynamic content, and the first tag; and store, by the video editor, the static video data and the metadata in the second video file format.

An example computer-implemented method comprises: receiving, into a video editor, static video data in a first video file format and metadata comprising dynamic content and a timeline of presenting the dynamic content along with the static video data; tagging at least a first portion of the dynamic content of the metadata with a first tag to indicate dynamic content; assembling, into a second video file format, the static video data and the metadata comprising the dynamic content, the timeline of presenting the dynamic content, and the first tag; and storing, by the video editor, the static video data and the metadata in the second video file format.

One or more example computer storage devices have computer-executable instructions stored thereon, which, on execution by a computer, cause the computer to perform operations comprising: receiving, into a video editor, static video data in a first video file format and metadata comprising dynamic content and a timeline of presenting the dynamic content along with the static video data; tagging at least a first portion of the dynamic content of the metadata with a first tag to indicate dynamic content; assembling, into a second video file format, the static video data and the metadata comprising the dynamic content, the timeline of presenting the dynamic content, and the first tag; and storing, by the video editor, the static video data and the metadata in the second video file format.

Alternatively, or in addition to the other examples described herein, examples include any combination of the following:
the first tag comprises an embedded type tag to indicate embedded dynamic content or a referenced type tag to indicate referenced dynamic content;
separately tagging at least a second portion of the dynamic content of the metadata with a second tag;
the second portion is a different portion of the dynamic content of the metadata than the first portion;
the second tag comprises an embedded type tag to indicate embedded dynamic content or a referenced type tag to indicate referenced dynamic content;
tagging, within the first portion of the metadata, at least a third portion of the dynamic content with an embedded type tag to indicate embedded dynamic content;
tagging, within the first portion of the metadata, at least a fourth portion of the dynamic content with a referenced type tag to indicate referenced dynamic content;
tagging, within the first portion of the metadata, at least a fifth portion of the dynamic content with the embedded type tag to indicate embedded dynamic content;
tagging, within the first portion of the metadata, at least a sixth portion of the dynamic content with the referenced type tag to indicate referenced dynamic content;
the first video file format and/or the second video file format comprises a video format selected from the list consisting of: MP4, MOV, AVI, WMV, MKV, WebM, OGV, and QTFF;
the first video file format is the second video file format;
the metadata further comprises positioning information for positioning a display of the dynamic content relative to a display of the static video data;
the positioning information comprises layering information;
the dynamic content comprises a reference to a source of additional data to display

along with the static video data;
the metadata further comprises settings for display of the additional data;
the settings for display of the additional data comprises at least one setting selected from the list consisting of: a geo-coordinate, a compass heading, a zoom factor, a start timestamp, a stop timestamp, and a font parameter;
the dynamic content comprises audio content separate from the static video data;
the dynamic content comprises content to display along with the static video data;
the content to display comprises text or data in a predefined file format;
the predefined file format comprises a file format selected from the list consisting of:
JSON, XML, AAF, a 2D image file format, and a 3D object file format;
the dynamic content comprises a plurality of portions each having a different start time and/or a different stop time;
the timeline comprises a start time and/or a stop time for presenting each portion of the dynamic content;
the timeline comprises a speed indication for presenting each portion of the dynamic content;
the static video data comprises both a static video data stream and a static audio data stream synchronized with the static video data stream;
the reference comprises a URL or a hyperlink indicating the source of additional data; and
the font parameter comprises style, size, or color.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 7 is a block diagram of an example computing device 700 (e.g., a computer storage device) for implementing aspects disclosed herein, and is designated generally as computing device 700. In some examples, one or more computing devices 700 are provided for an on-premises computing solution. In some examples, one or more computing devices 700 are provided as a cloud computing solution. In some examples, a combination of on-premises and cloud computing solutions are used. Computing device 700 is but one example of a suitable computing environment and is not intended to suggest any limitation as to the scope of use or functionality of the examples disclosed herein, whether used singly or as part of a larger set.

Neither should computing device 700 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 700 includes a bus 710 that directly or indirectly couples the following devices: computer storage memory 712 (i.e., a computer-readable medium), one or more processors 714, one or more presentation components 716, input/output (I/O) ports 718, I/O components 720, a power supply 722, and a network component 724. While computing device 700 is depicted as a seemingly single device, multiple computing devices 700 may work together and share the depicted device resources. For example, memory 712 may be distributed across multiple devices, and processor(s) 714 may be housed with different devices.

Bus 710 represents what may be one or more buses (such as an address bus, data bus, or a combination thereof). Although the various blocks of FIG. 7 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 7 and the references herein to a “computing device.” Memory 712 may take the form of the computer storage media referenced below and operatively provide storage of computer-readable instructions, data structures, program modules and other data for the computing device 700. In some examples, memory 712 stores one or more of an operating system, a universal application platform, or other program modules and program data. Memory 712 is thus able to store and access data 712a and instructions 712b that are executable by processor 714 and configured to carry out the various operations disclosed herein. Thus, computing device 700 comprises a computer storage device having computer-executable instructions 712b stored thereon.

In some examples, memory 712 includes computer storage media. Memory 712 may include any quantity of memory associated with or accessible by the computing device 700. Memory 712 may be internal to the computing device 700 (as shown in FIG. 7), external to the computing device 700 (not shown), or both (not shown). Additionally, or alternatively, the memory 712 may be distributed across multiple computing devices 700, for example, in a virtualized environment in which instruction processing is carried out on multiple computing devices 700. For the purposes of this disclosure, “computer storage media,” “computer storage memory,” “memory,” and “memory devices” are synonymous terms for the memory 712, and none of these terms include carrier waves or propagating signaling.

Processor(s) 714 may include any quantity of processing units that read data from various entities, such as memory 712 or I/O components 720. Specifically, processor(s) 714 are programmed to execute computer-executable instructions for implementing aspects of the disclosure. The instructions may be performed by the processor, by multiple processors within the computing device 700, or by a processor external to the client computing device 700. In some examples, the processor(s) 714 are programmed to execute instructions such as those illustrated in the flow charts discussed below and depicted in the accompanying

drawings. Moreover, in some examples, the processor(s) 714 represents an implementation of analog techniques to perform the operations described herein. For example, the operations may be performed by an analog client computing device 700 and/or a digital client computing device 700. Presentation component(s) 716 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 700, across a wired connection, or in other ways. I/O ports 718 allow computing device 700 to be logically coupled to other devices including I/O components 720, some of which may be built in. Example I/O components 720 include, for example but without limitation, a microphone, joystick, game pad, satellite dish, scanner, printer, wireless device, etc.

Computing device 700 may operate in a networked environment via the network component 724 using logical connections to one or more remote computers. In some examples, the network component 724 includes a network interface card and/or computer-executable instructions (e.g., a driver) for operating the network interface card. Communication between the computing device 700 and other devices may occur using any protocol or mechanism over any wired or wireless connection. In some examples, network component 724 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 724 communicates over wireless communication link 726 and/or a wired communication link 726a to a remote resource 728 (e.g., a cloud resource) across a computer network 730. Various different examples of communication links 726 and 726a include a wireless connection, a wired connection, and/or a dedicated link, and in some examples, at least a portion is routed through the internet.

Although described in connection with an example computing device 700, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
receive, into a video editor, static video data in a first video file format and metadata comprising dynamic content and a timeline of presenting the dynamic content along with the static video data;
tag at least a first portion of the dynamic content of the metadata with a first tag to indicate dynamic content;
assemble, into a second video file format, the static video data and the metadata comprising the dynamic content, the timeline of presenting the dynamic content, and the first tag; and
store, by the video editor, the static video data and the metadata in the second video file format.

2. The system of claim 1, wherein the first tag comprises an embedded type tag to indicate embedded dynamic content or a referenced type tag to indicate referenced dynamic content.

3. The system of claim 2, wherein the instructions are further operative to:
separately tag at least a second portion of the dynamic content of the metadata with a second tag, wherein the second portion is a different portion of the dynamic content of the metadata than the first portion, and wherein the second tag comprises an embedded type tag to indicate embedded dynamic content or a referenced type tag to indicate referenced dynamic content.

4. The system of claim 1, wherein the instructions are further operative to:
tag, within the first portion of the metadata, at least a third portion of the dynamic content with an embedded type tag to indicate embedded dynamic content; and/or tag, within the first portion of the metadata, at least a fourth portion of the dynamic content with a referenced type tag to indicate referenced dynamic content.

5. The system of claim 4, wherein the instructions are further operative to:
tag, within the first portion of the metadata, at least a fifth portion of the dynamic content with the embedded type tag to indicate embedded dynamic content; and/or tag, within the first portion of the metadata, at least a sixth portion of the dynamic content with the referenced type tag to indicate referenced dynamic content.

6. The system of claim 1, wherein the dynamic content comprises a plurality of portions each having a different start time and/or a different stop time.

7. A computer-implemented method comprising:
receiving, into a video editor, static video data in a first video file format and metadata comprising dynamic content and a timeline of presenting the dynamic content along with the static video data;
tagging at least a first portion of the dynamic content of the metadata with a first tag to indicate dynamic content;
assembling, into a second video file format, the static video data and the metadata comprising the dynamic content, the timeline of presenting the dynamic content, and the first tag; and
storing, by the video editor, the static video data and the metadata in the second video file format.

8. The computerized method of claim 7, wherein the first tag comprises an embedded type tag to indicate embedded dynamic content or a referenced type tag to indicate referenced dynamic content.

9. The computerized method of claim 8, further comprising:
separately tagging at least a second portion of the dynamic content of the metadata with a second tag, wherein the second portion is a different portion of the dynamic content of the metadata than the first portion, and wherein the second tag comprises an embedded type tag to indicate embedded dynamic content or a referenced type tag to indicate referenced dynamic content.

10. The computerized method of claim 7, further comprising:
tagging, within the first portion of the metadata, at least a third portion of the dynamic content with an embedded type tag to indicate embedded dynamic content; and/or
tagging, within the first portion of the metadata, at least a fourth portion of the dynamic content with a referenced type tag to indicate referenced dynamic content.

11. The computerized method of claim 10, further comprising:
tagging, within the first portion of the metadata, at least a fifth portion of the dynamic content with the embedded type tag to indicate embedded dynamic content; and/or
tagging, within the first portion of the metadata, at least a sixth portion of the dynamic content with the referenced type tag to indicate referenced dynamic content.

12. The computerized method of claim 7, wherein the first video file format and/or the second video file format comprises a video format selected from the list consisting of:
MP4, MOV, AVI, WMV, MKV, WebM, OGV, and QTFF.

13. The computerized method of claim 7, wherein the first video file format is the second video file format.

14. The computerized method of claim 7, wherein the metadata further comprises positioning information for positioning a display of the dynamic content relative to a display of the static video data.

15. The computerized method of claim 14, wherein the positioning information comprises layering information.

16. A computer storage device having computer-executable instructions stored thereon, which, on execution by a computer, cause the computer to perform operations comprising:
receiving, into a video editor, static video data in a first video file format and metadata comprising dynamic content and a timeline of presenting the dynamic content along with the static video data;
tagging at least a first portion of the dynamic content of the metadata with a first tag to indicate dynamic content;
assembling, into a second video file format, the static video data and the metadata comprising the dynamic content, the timeline of presenting the dynamic content, and the first tag; and
storing, by the video editor, the static video data and the metadata in the second video file format.

17. The computer storage device of claim 16, wherein the metadata further comprises positioning information for positioning a display of the dynamic content relative to a display of the static video data.

18. The computer storage device of claim 17, wherein the positioning information comprises layering information.

19. The computer storage device of claim 16, wherein the dynamic content comprises a reference to a source of additional data to display along with the static video data, wherein the metadata further comprises settings for display of the additional data, and wherein the settings for display of the additional data comprises at least one setting selected from the list consisting of: a geo-coordinate, a compass heading, a zoom factor, a start timestamp, a stop timestamp, and a font parameter.

20. The computer storage device of claim 16, wherein the dynamic content comprises a plurality of portions each having a different start time and/or a different stop time.
